(19) United States
(12) Patent Application Publication
(10) Pub. No.: US 2009/0067706 A1
(43) Pub. Date: Mar. 12, 2009

(54) System and Method for Multiframe Surface Measurement of the Shape of Objects

(75) Inventor: Nikolay L. Lapa, Jaroslavl' (RU)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: Artec Ventures, Moscow (RU)

(21) Appl. No.: 11/854,518

(22) Filed: Sep. 12, 2007

(51) Int. Cl. G01B 11/24

(52) U.S. Cl. 382/154

(57) ABSTRACT

A system and method are provided for the multiframe surface measurement of the shape of material objects. The system and method include capturing a plurality of images of portions of the surface of the object being measured and merging the captured images together in a common reference system. The shape and/or texture of a complex-shaped object can be measured using a 3D scanner by capturing multiple images from different perspectives and subsequently merging the images in a common coordinate system to align the merged images together. Alignment is achieved by capturing images of both a portion of the surface of the object and also of a reference object having known characteristics (e.g., shape and/or texture). This allows the position and orientation of the object scanner to be determined in the coordinate system of the reference object.

### BACKGROUND OF THE INVENTION

1. Field of the Invention

The disclosure relates to the three-dimensional (“3D”) surface measurement of material objects.

2. Background Discussion

There are known devices and methods for performing non-contact measurement of a 3-D surface shape of a material object, such as through the use of a structured-light or stereoscopic triangulation method. The structured-light triangulation method of measuring the surface shape of material objects utilizes the projection of structured light onto the surface of the object that is, generally, an amplitude-modulated, time-modulated and/or wavelength-modulated (“structured light”). An image of structured light projected onto the surface of an object (hereinafter referred to as “the image”) is captured by a camera in a direction different from the direction that the structured light is projected. The image is then analyzed to calculate the shape of the object's surface.

3D scanners use such triangulation methods to measure the surface shape of an entire object. However, 3D scanners can typically only measure a portion of the surface of the object at a time, and it is typically necessary to make a series of scans from various angles and then merge the resulting 3D images together in order to measure the shape of the entire surface. To avoid noticeable mistakes when merging the series of scans together, it is necessary to know the point and direction from which each scan was made with an accuracy no less than accuracy of each scan.

A number of solutions have previously been attempted to achieve this level of accuracy, including: 1) fixing the 3D scanner in place and using a precise rotating table to mount the object, 2) using a precision device to move the scanner around the object, 3) identifying the position and orientation of the scanner by using an array of sensors (e.g., radio, optical, or magnetic sensors) positioned around the vicinity of the object to determine the position of an emitter installed inside the 3D scanner, and 4) using several 3D scanners mounted on a rigid structure distributed about the object.

However, each of the prior attempted solutions suffer from a number of shortcomings: high costs, bulkiness, non-portability, long scanning times, inability to scan moving objects, and certain application limitations (e.g., they cannot be used to scan sensitive objects that cannot be moved or touched such as museum exhibits).

### SUMMARY

In accordance with one or more embodiments, a system and method are provided for the multiframe surface measurement of the shape of material objects. The system and method include capturing a plurality of images of portions of the surface of the object being measured and merging the captured images together in a common reference system. In one aspect, the shape and/or texture of a complex-shaped object can be measured using a 3D scanner by capturing multiple images from different positions and perspectives and subsequently merging the images in a common coordinate system to align the merged images together. Alignment is achieved by capturing images of both a portion of the surface of the object and also a reference surface having known characteristics (e.g., shape and/or texture). This allows the position and orientation of the object scanner to be determined in the coordinate system of the reference object. The position of the device capturing an image of the object can be further controlled with respect to the device capturing the image of the reference object to ensure consistency in precision between captured images of the object.

### DRAWINGS

The above-mentioned features and objects of the present disclosure will become more apparent with reference to the following description taken in conjunction with the accompanying drawings wherein like reference numerals denote like elements and in which:

FIG. 1 is a block diagram perspective view of a system for the multiframe surface measurement of the shape of material objects in accordance with one or more embodiments of the present disclosure.

FIG. 2 is an operational flow diagram of a method for the multiframe surface measurement of the shape of material objects in accordance with one or more embodiments of the present disclosure.

FIG. 3 is a block diagram perspective view of a system for the multiframe surface measurement of the shape of material objects in accordance with one or more embodiments of the present disclosure.

FIGS. 4A-4B are a block diagram perspective views of a system for the multiframe surface measurement of the shape of material objects in accordance with one or more embodiments of the present disclosure.

FIG. 5 is a block diagram perspective view of a system for the multiframe surface measurement of the shape of material objects in accordance with one or more embodiments of the present disclosure.

FIG. 6 is a block diagram representation of a system for the multiframe surface measurement of the shape of material objects in accordance with one or more embodiments of the present disclosure.

FIG. 7 is a block diagram representation of a system for the multiframe surface measurement of the shape of material objects in accordance with one or more embodiments of the present disclosure.

### DETAILED DESCRIPTION

In general, the present disclosure includes a system and method for the multiframe surface measurement of the shape of material objects in accordance with one or more embodiments of the present disclosure. Certain embodiments of the present disclosure will now be discussed with reference to the aforementioned figures, wherein like reference numerals refer to like components.

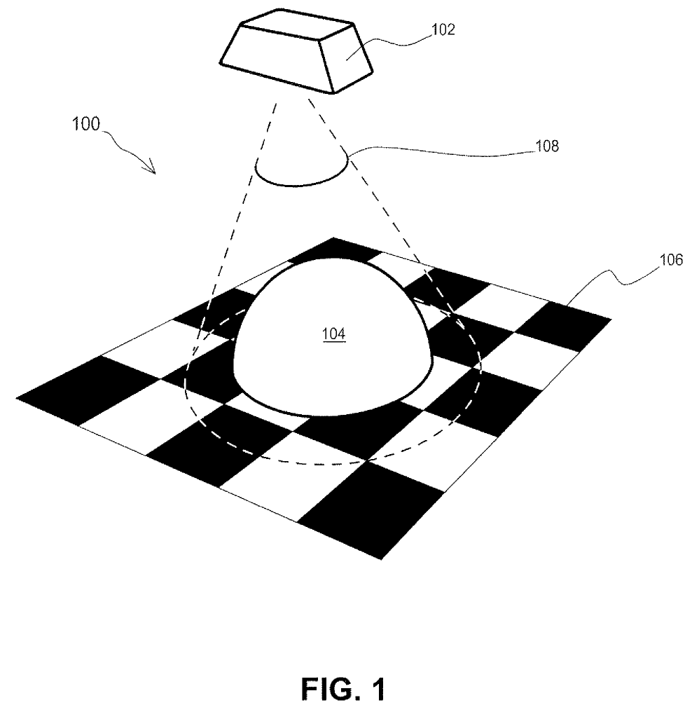

Referring now to FIG. 1, a block diagram illustration of a system 100 for the multiframe surface measurement of the shape of material objects is shown generally in accordance with one or more embodiments. The system 100 includes a scanning device 102 for scanning the surface of an object 104. Scanning device 102 may comprise a 3D scanner for capturing an image of an object, a photometric scanner or camera for capturing photometric characteristics of the object 104 (e.g., 2D image texture, color, brightness, etc.), another type of image capturing device or a combination thereof. Hereinafter, for purposes of brevity, scans that are performed in connection with determining 3D measurements (e.g., shape) of the surface of the object 104 will be referred to as “surface scanning,” and scans that are performed in connection with determining photometric characteristics, texture or other 2D measurements of the object 104 will be referred to as “texture scanning.” Further, the term image as used herein when used by itself shall refer to a 3D image, a 2D image, another type of image, or any combination of any of the foregoing types of images. The object 104 is positioned adjacent to a reference object 106. In one or more embodiments, the scanning device 102 includes a field of view 108 that at least partially includes a portion of the object 104 and a portion of the reference object 106. The field of view 108 is preferably conical but may comprise other shaped fields as well.

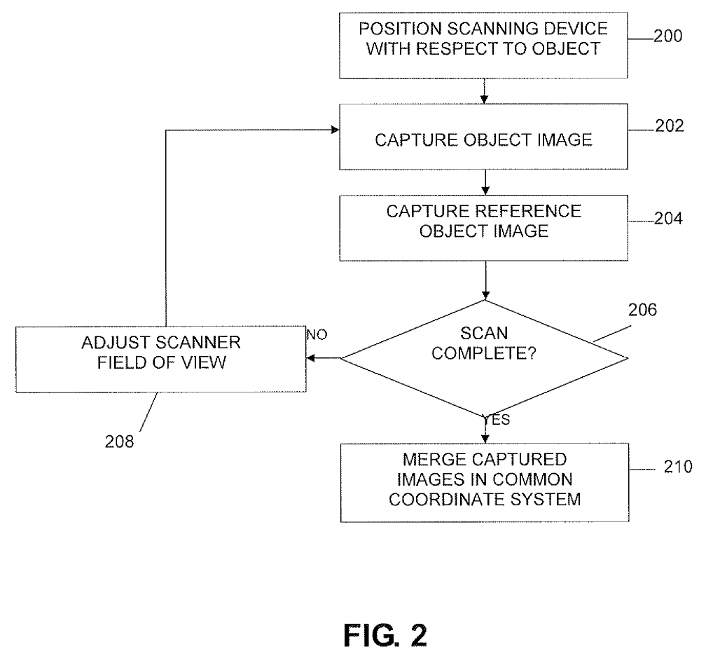

With further reference to FIG. 2, an operational flow diagram is illustrated for the process employed by the system 100 for the multiframe surface measurement of the shape of the object 104. Initially, in step 200 the scanning device 102 is positioned in a desired relationship with respect to the object 104. The scanning device 102 then captures an image of at least a portion of the object 104 in step 202, while the scanning device 102 also captures an image of at least a portion of the reference object 106 in step 204. In one or more embodiments, the image of the object 104 captured by the scanning device 102 includes at least a 3D image of the object 104 and optionally also includes a 2D image or another type of image of the object 104. In one or more embodiments, the image of the reference object 106 captured by the scanning device 102 is at least one of a 3D image or a 2D image. Steps 202 and 204 may be performed separately or alternatively as part of the same image capturing step or alternatively in the reverse sequence. In one or more embodiments, the reference object 106 includes certain reference characteristics such as but not limited to a coded pattern and/or a certain shape. In one embodiment, the object 104 is maintained motionless in relation to the reference object 106 (e.g. such as by mounting the object 104 on the reference object 106 or vice versa) while the image is being captured. In another embodiment, the object 104 and the reference object 106 can move in relation to each other during scanning.

It is then determined in step 206 whether the scan is complete and the desired image of the object 104 has been captured in its entirety. If the image capture is not complete, then the field of view 108 of the scanning device 102 is adjusted with respect to the object 104 in step 208 in order to capture an image of another portion of the object 104. For example, the position of the entire scanning device 102 can be moved or the camera field of view 108 can be adjusted. The process then returns to steps 202/204 to perform another image capture of at least a portion of the object 104 and at least a portion of the reference object 106. The above steps are successively repeated until enough images (e.g., frames) of the desired portion of the object 104 are captured. In each of the positions of the scanning device 102, the field of view 108 must contain at least a portion of the reference object 106 sufficient for determining the position and orientation of the scanning device 102 in the coordinate system of the reference object 106. In step 210, the multiple captured images or frames are combined together into a common coordinate system of the reference object 106 using any known coordinate transformation technique. Each captured image can be considered a frame that is merged together to form the multiframe image of the object 104 that can be used to calculate a surface measurement of the object 104.

In this manner and in one aspect the shape and/or texture of a complex-shaped object 104 can be measured using a scanning device 102 by capturing multiple images of the object 104 from different points of view and directions and subsequently merging the captured images or frames in a common coordinate system to align the merged images together. Alignment is achieved by capturing both a portion of the surface of the object 104 and also a reference object 106 having known characteristics (e.g., shape and texture). This allows the position and orientation of the scanning device 102 to be determined in the coordinate system of the reference object 106.

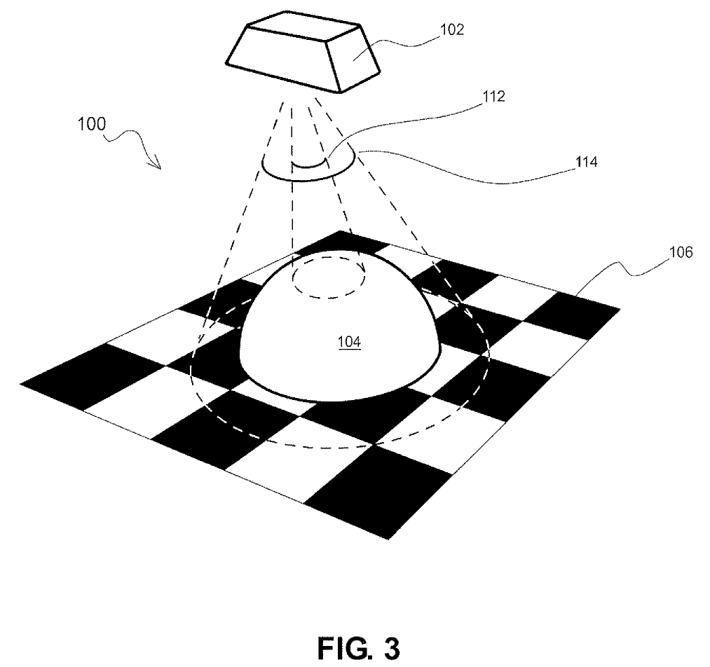

Referring now to FIG. 3, in one or more embodiments, the scanning device 102 may comprise multiple scanners or cameras with multiple fields of view: at least one field of view 112 for capturing shape measurement (e.g., surface scanning) and at least one field of view 114 for capturing the surface texture (e.g., texture scanning). Each of the fields of view 112 and 114 encompass at least a portion of the object 104 being imaged, where at least one of the fields of view 112 and 114 must also contain at least a portion of the reference object 106 sufficient for determining the position and orientation of the scanning device 102 in the coordinate system of the reference object 106. During the image capturing process, the position or orientation of the scanning device 102 is successively changed so as to cover all positions necessary for the fields of view 112 and 114 to capture the entire desired surface of the object 104. In each of these orientations, at least one of the fields of view 112 and 114 must contain a portion of the reference object 106. The images captured by the surface scanning and texture scanning can then be combined in the common coordinate system of the reference object 106.

In one or more embodiments, one of the fields of view 112 and 114 can be used for a reference image, such that the position and orientation of the scanning device 102 associated with the other of the fields of view 112 and 114 can be converted into the reference object 106's coordinate system.

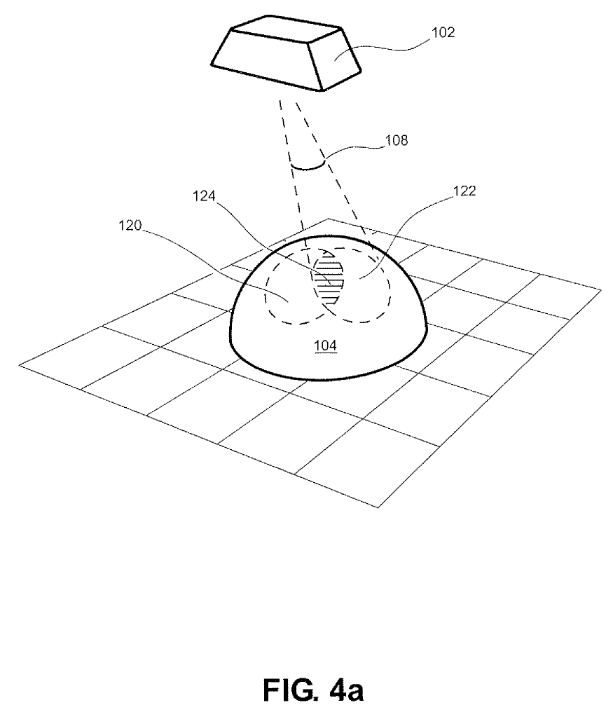

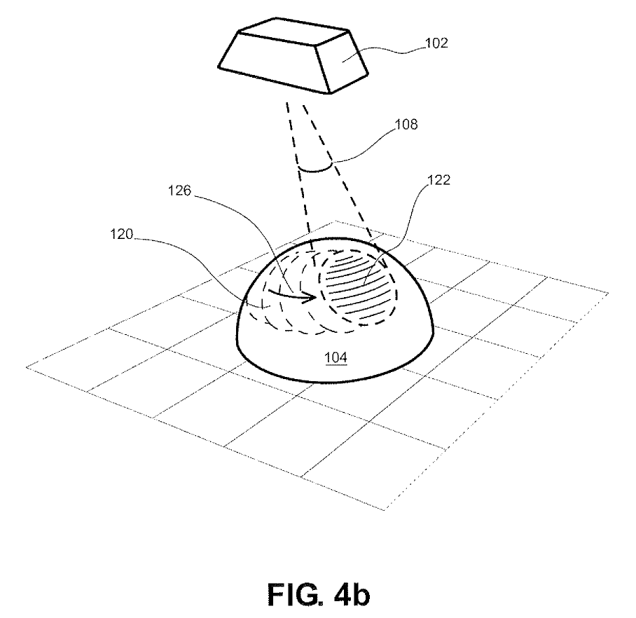

Referring now to FIG. 4A, in one or more embodiments, the system 100 for the multiframe surface measurement of the shape of material objects can utilize a portion 120 of the object 104 being having known characteristics (e.g., an already known or previously calculated shape and/or texture) to supply the reference characteristics instead of a separate reference object. The first portion 120 of the object 104 to be captured is selected to contain certain known, previously calculated or easily calculated shape and textural features. The subsequent images that are captured by the scanning device 102 on different portions of the object 104 will be made in the coordinate system of the portion 120 already captured. The field of view 108 of the portion of the object 104 to imaged includes part of the previously captured portion 120 that is sufficient for determining the position and orientation of the scanning device 102 in relation to it. For a portion 122 being currently captured, there will be an overlapping region 124 on the object 102 that includes a portion of the previously captured portion 120. In this manner, the previously captured portion 120 serves as the reference object. The scanning device 102 illustrated in FIG. 4A is illustrated having a single field of view 108; however, it is understood that in this and in all other embodiments described herein that the field of view 108 may also include a plurality of fields of view (e.g., the pair of surface scanning field of view 112 and texture scanning field of view 114).

Referring now to FIG. 4B, in one or more embodiments, the known portion 120 will continue to expand subsequent image captures, for instance, as illustrated by the directional arrow 126 showing the movement of the previous fields of view 108 of the scanning device 102. The field of view 108 moves in such a manner that each subsequent section of the object 104 to imaged includes part of the previously captured portion 120 that is sufficient for determining the position and orientation of the scanning device 102 in relation to it. Thus, with each subsequent image captures, the known portion 120 increases in size (accumulating) until it encompassed the entire desired portion of the object 104 to be captured.

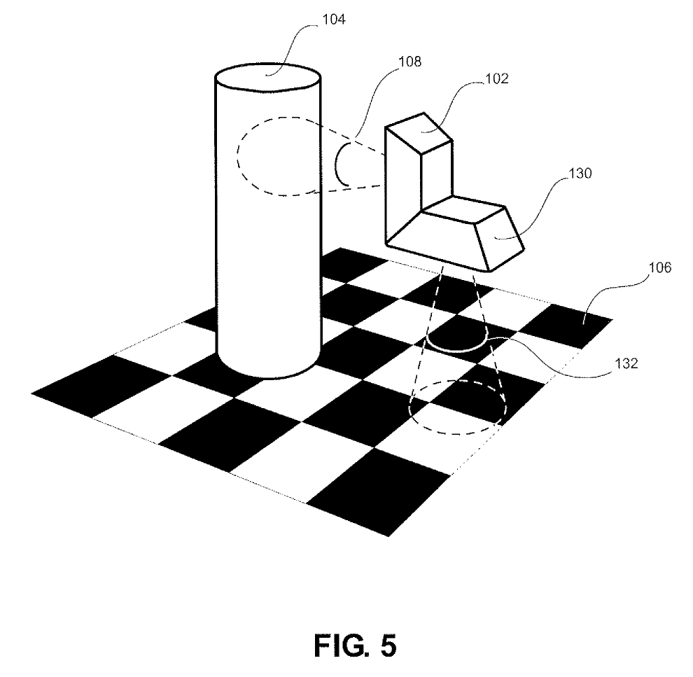

Referring now to FIG. 5, in one or more embodiments, the system 100 for the multiframe surface measurement of the shape of material objects may include an additional scanning device 130 having an additional field of view 132, where field of view 132 may include both a surface scanning field of view 112 and a texture scanning field of view 114. The scanning device 102 captures an image of the object 104 for measuring the shape and/or surface texture of the object, while the other scanning device 130 includes a field of view 132 in a different direction from the object 104 that captures an image of the reference object 106 for determining the spatial position of the scanning device 130. Through a known relationship between the object scanning device 102 and the reference object scanning device 130, the position and orientation of the object scanning device 102 can be converted into the reference object 106's coordinate system.

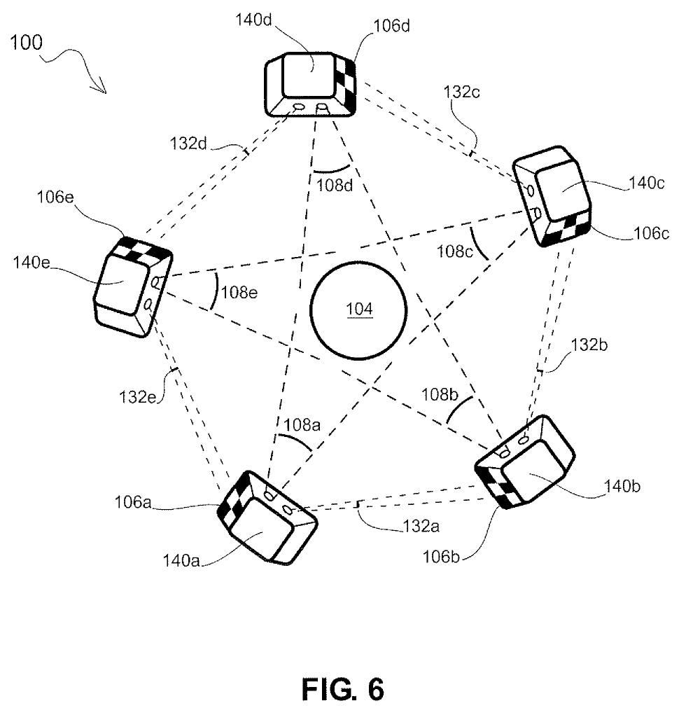

Referring now to FIG. 6, in one or more embodiments, the system 100 for the multiframe surface measurement of the shape of material objects may include a plurality of scanning devices 140 (e.g., 140a, 140b, 140c, 140d, 140e . . . ) that each have a respective reference object 106 (e.g., 106a, 106b, 106c, 106d, 106e . . . ) positioned thereon. Similar to the embodiments described in connection with FIG. 5, each scanning device 140 includes a respective field of view 108 (or pair of fields of view 112 and 114) of the object 104 being captured and also a respective reference object field of view 132 of an adjacent reference object 106 located on an adjacent scanning device 140. In one embodiment, the scanning devices 140 are positioned in a succession around the object 104, with each device 140's fields of view 108 capturing a portion of the object 102 being scanned while a second field of view 132 captures at least a portion of the reference object 106 mounted on the next scanning device 140 in the succession. For instance, scanning device 140a will have a field of view 108a (or pair of fields of view 112a and 114a) of the object 104 and will also have a field of view 132a of the reference object 106b located on the adjacent scanning device 140b. Each of the scanning devices 140 can determine its position in the coordinate system of the reference object 106 it captures its field of view 132. The continuity of such an arrangement in succession enables all of the captured images of the reference objects 106 (e.g., 106a, 106b, 106c, 106d, 106e . . . ) to be converted into a common coordinate system. In one or more embodiments, each scanning device 140 can comprise a pair of scanning devices 102 and 130 similar to the arrangement described in connection with FIG. 5, where through a known relationship between each object scanning device 102 and its respective reference object scanning device 130, the position and orientation of the object scanning device 102 can be converted into common coordinate system of the reference object 106.

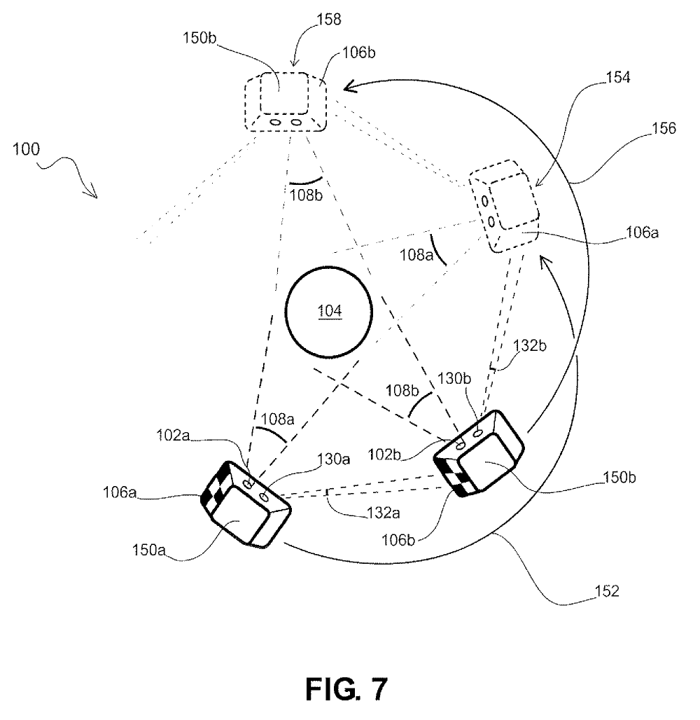

Referring now to FIG. 7, in one or more embodiments, the system 100 for the multiframe surface measurement of the shape of material objects can perform successive object captures and reference object captures using successive captures at locations around the object 104, similar to the successive system of FIG. 6, but by using only two scanning devices 150a and 150b that are moved in relation to one another one by one to various positions around the object 104. Each scanning device 150a and 150b includes an object scanning device 102 having a field of view 108 and a reference object scanning device 130 having a reference object field of view 132, similar to the embodiment described in connection with FIG. 6. Each of the scanning devices 150a and 150b also includes a respective reference object 106a and 106b mounted thereon.

In one or more embodiments, each step of moving of the scanning devices 150a and 150b in other position around the object 104 comprises: a) moving one of the scanning devices 150a and 150b in another position such that the moved scanning device has a respective field of view 108 of at least a portion of the surface of the object 104 being captured and such that the scanning device 150 that was not moved has a respective field of view 132 of at least a portion of the surface of the reference object 106 mounted on the scanning device 150 that was moved; b) capturing images of the respective portions of the surface of the object 104 to be captured in the field of views 108a and 108b of each of the scanning devices 150a and 150b and capturing an image of the respective portion of the surface of the reference object 106 in the field of view 132 of the scanning device 150 that was not moved; c) transforming the captured images of the respective portions of the surface of the object 104 to be measured as well as the images of the portions of the object 104 to be measured captured and merged from prior configurations into a common reference coordinate system of one of the reference objects 106 that, in one or more embodiments, can be the reference object 106 mounted on the scanning device 150 that was moved; d) merging the images of the respective portions of the surface of the object 104 to be measured in the coordinate system of one of the reference objects 106 with the images of the portions of the object 104 to be measured captured and merged from prior configurations. In one or more embodiments, at the first step of moving one of the scanning devices 150a and 150b to another position, either of the scanning devices 150a and 150b can be moved. In one or more embodiments, at each step except the first positioning step, the scanning device 150 that is moved should be the scanning device 150 that was not moved at the previous repositioning step.

An example of the foregoing operation of the system 100 of FIG. 7 will now be set forth. Each of the scanning devices 150a and 150b are positioned in relation to the object 104 such that the field of view 132a of the scanning device 150a observes the reference object 106b on the scanning device 150b. The scanning device 150b captures an image of a portion of the object 104 from field of view 108b, while scanning device 150a captures an image of another portion of the object 104 from field of view 108a. The scanning device 150a also captures an image of the reference object 106b on the scanning device 150b and determines the position of the scanning device 150a in the coordinate system of the reference object 106b of the scanning device 150b. The images captured of the object 104 in the field of views 108a and 108b by the scanning devices 150a and 150b are then converted to the coordinate system of the reference object 106b and merged together in the coordinate system of the reference object 106b.

One of the scanning devices 150, e.g., scanning device 150a, is then moved to a different position in relation to the object 104, so that the reference object field of view 132b of the scanning device 150b observes the reference object 106a mounted on the scanning device 150a, For instance, the scanning device 150a can be moved as indicated by directional arrow 152.

The scanning device 150a then captures an image of a portion of the object 104 from field of view 108a at new position 154 and transforms the captured image into the coordinate system of the reference object 106a. Scanning device 150b also captures an image of the reference object 106a mounted on the scanning device 150a and determines the position of the scanning device 150b in the reference object 106a coordinate system. The portion of the object 104 previously captured by the scanning devices 150a and 150b and previously merged together are then converted to the coordinate system of the reference object 106a and merged with the image of the portion of the object 104 captured from field of view 108a at new position 154.

The other scanning device 150, e.g., scanning device 150b, that was not the one that was just previously moved is then is moved to a different position in relation to the object 104, so that the reference object field of view 132a of the scanning device 150a observes the reference object 106b mounted on the scanning device 150b. For instance, the scanning device 150b can be moved as indicated by directional arrow 156 to new position 158. The scanning device 150b then captures a new image of the object 104 at position 158, Scanning device 150a captures an image of the reference object 106b and determines the position of the scanning device 150a in the coordinate system of the reference object 150b. The portion of the surface of the object 104 previously scanned and merged in the reference object 150a coordinate system is converted to the reference object 150b coordinate system and merged with the object image captured by the scanning device 150b at position 158. This process of alternatingly resituating the scanning devices 150a and 150b is repeated until the entire surface of the object 104 has been captured in a frame-by-frame format and merged into a multiframe image in a common coordinate system.

In one or more embodiments, the scanning devices 102, 130, 140 and 150 can be connected to a computing system (not shown) for controlling the operation of the scanning devices 102, 130, 140 and 150 and also for performing the necessary calculations for coordinate conversation, merging and other image processing. The computing system may comprise a general-purpose computer system which is suitable for implementing the method for the multiframe surface measurement of the shape of material objects in accordance with the present disclosure. The computing system is only one example of a suitable computing environment and is not intended to suggest any limitation as to the scope of use or functionality of the invention. In various embodiments, the present system and method for the multiframe surface measurement of the shape of material objects is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, programmable consumer electronics, networked PCs, minicomputers, mainframe computers, distributed computing environments that include any of the above systems or devices, and the like.

In various embodiments, the triangulation algorithms and the method for the multiframe surface measurement of the shape of material objects may be described in the general context of computer-executable instructions, such as program modules, being executed by a computer. Generally, program modules include routines, programs, objects, components, data structures, etc. that perform particular tasks or implement particular abstract data types. These algorithms and methods may also be practiced in distributed computing environments where tasks are performed by remote processing devices that are linked through a communications network. In a distributed computing environment, program modules may be located in both local and remote computer storage media including memory storage devices. In one embodiment, the computing system implements multiframe surface measurement of the shape of material objects by executing one or more computer programs. The computer programs may be stored in a memory medium or storage medium such as a memory and/or ROM, or they may be provided to a CPU through a network connection or other I/O connection.

The system and method formed in accordance with the embodiments described herein provide for the accurate measurement of the surface and/or texture of large and/or complex-shaped objects by allowing multiple frames of images to be merged together in a common coordinate system. These teachings can be applied to a whole range of scientific and engineering problems that require accurate data about the surface shape of an object, distance to the surface, or its spatial orientation. The present system and method has useful applications in many fields, including but not limited to digital imaging, the control of part shapes, computer animation, capturing the shape of objects that have cultural, historical or scientific value, shape recognition, topography, machine vision, medical procedures, special positioning of devices and robots, etc.

1. A method for the surface measurement of a material object, comprising:
capturing at least one image of at least a portion of a surface of the object to be measured;
capturing at least one image of at least a portion of a surface of a reference object;
transforming captured images of the portions of the surface of the object to be measured into a coordinate system of the reference object; and
merging the captured images of the portions of the surface of the object to be measured in the coordinate system of the reference object.

2. The method of claim 1, wherein the captured images of the portions of the surface of the object to be measured includes three-dimensional (3D) images.

3. The method of claim 2, wherein the captured images of the portions of the surface of the object to be measured further includes two-dimensional (2D) images.

4. The method of claim 2, wherein each image of a portion of the surface of the object to be measured is captured in the same image as a corresponding image of a portion of the surface of the reference object.

5. The method of claim 2, wherein the reference object comprises a portion of the object to be measured that has been previously measured to identify certain reference characteristics.

6. The method of claim 5, further comprising:
merging a captured image of a portion of the surface of the object to be measured with the reference object image, wherein the merged image is subsequently used as the reference object image for later images of the portions of the surface of the object to be measured.

7. The method of claim 2, wherein the images of the portions of the surface of the object to be measured are captured in field of views that are wholly separate from field of views for capturing of the images of the portions of the reference object.

8. The method of claim 2, further comprising:
positioning a plurality of scanning devices in various locations with respect to the object to be measured such that each of the scanning devices has a respective first field of view of at least a portion of the object,
wherein each of the plurality of scanning devices includes a reference object having certain reference characteristics positioned thereon,
wherein each of the plurality of scanning devices has a respective second field of view to capture at least a portion of a reference object,
wherein each of the plurality of scanning devices is positioned with respect one another such that the second field of view of at least one of the scanning devices observes at least a portion of the surface of the reference object of another scanning device;
capturing images of the respective portions of the surface of the object to be measured in the first field of view of each of the scanning devices;
capturing images of the respective portions of the surface of the reference objects in the second field of view of each of the scanning devices that observes respective reference objects;
transforming the captured images of the respective portions of the surface of the object to be measured into a common reference coordinate system of one of the reference objects, and
merging all of the captured images of the respective portions of the surface of the object to be measured together in a common coordinate system of one of the reference objects.

9. The method of claim 2, further comprising:
positioning first and second scanning devices at a first configuration with respect to the object to be measured such that each of the scanning devices has a respective first field of view of at least a portion of the surface of the object to be measured,
wherein each of the scanning devices includes a reference object having certain reference characteristics positioned thereon,
wherein each of the scanning devices has a respective second field of view to capture at least a portion of the surface of a reference object,
wherein the scanning devices are positioned with respect one another such that the second field of view of one of the scanning devices observes at least a portion of the surface of the reference object located on the other scanning device;
capturing images of the respective portions of the surface of the object to be measured in the first field of view of each of the scanning devices;
capturing an image of the respective portion of the surface of the reference object in the second field of view of the scanning device that observes the respective portion of the surface of the reference object;
transforming captured images of the respective portions of the surface of the object to be measured captured at first configuration into a coordinate system of one of the reference objects;
merging the images of the respective portions of the surface of the object to be measured captured at first configuration in the coordinate system of one of the reference objects;
repetitively repositioning one of the first and second scanning devices one by one in an alternating manner in different configurations and;
capturing at each configuration images of the respective portions of the surface of the object to be measured in the first field of view of each of the scanning devices;
capturing at each configuration an image of the respective portion of the surface of the reference objects in the second field of view of the scanning device that observes the respective portion of the surface of the reference object;
transforming at each configuration captured images of the respective portions of the surface of the object to be measured and the images of the portions of the object to be measured captured and merged from prior configurations into a coordinate system of one of the reference objects;
merging at each configuration the images of the respective portions of the surface of the object to be measured in the coordinate system of one of the reference objects with the images of the portions of the object to be measured captured and merged from prior configurations.

10. The method of claim 2, wherein the captured three-dimensional (3D) image of a portion of the surface of the object to be measured is obtained with a structured-light triangulation method.

11. A system for the surface measurement of a material object, comprising:
at least one scanning device for capturing at least one image of at least a portion of a surface of the object to be measured and for capturing at least one image of at least a portion of a surface of a reference object; and
a computing device for transforming captured images of the portions of the surface of the object to be measured into a coordinate system of the reference object and for merging the captured images of the portions of the surface of the object to be measured in the coordinate system of the reference object.

12. The system of claim 11, wherein the captured images of the portions of the surface of the object to be measured includes three-dimensional (3D) images.

13. The system of claim 12, wherein the captured images of the portions of the surface of the object to be measured further includes two-dimensional (2D) images.

14. The system of claim 12, wherein the scanning device includes a field of view that allows an image of a portion of the surface of the object to be measured to be captured in the same image as a corresponding image of a portion of the surface of the reference object.

15. The system of claim 12, wherein the reference object comprises a portion of the object to be measured that has been previously measured to identify certain reference characteristics.

16. The system of claim 15, wherein the computing system further merges a captured image of a portion of the surface of the object to be measured with the reference object image, wherein the merged image is subsequently used as the reference object for later images of the portions of the surface of the object to be measured.

17. The system of claim 12, wherein the scanning devices capture images of the portions of the surface of the object to be measured in field of views that are wholly separate from field of views for capturing of the images of the portions of the reference object.

18. The system of claim 12, further comprising:
a plurality of scanning devices positionable in various locations with respect to the object to be measured such that each of the scanning devices has a respective first field of view of at least a portion of the object,
wherein each of the plurality of scanning devices includes a reference object having certain reference characteristics positioned thereon,
wherein each of the plurality of scanning devices has a respective second field of view to capture at least a portion of a reference object,
wherein each of the plurality of scanning devices is positioned with respect one another such that the second field of view of at least one of the scanning devices observes at least a portion of the surface of the reference object of another scanning device;
the plurality of scanning devices operative to capture images of the respective portions of the surface of the object to be measured in the first field of view of each of the scanning devices;
the plurality of scanning devices operative to capture images of the respective portions of the surface of the reference objects in the second field of view of each of the scanning devices that observes respective reference objects;
the computing device operative to transform the captured images of the respective portions of the surface of the object to be measured into a common reference coordinate system of one of the reference objects; and
the computing device operative to merge all of the captured images of the respective portions of the surface of the object to be measured together in a common coordinate system of one of the reference objects.

19. The system of claim 12, further comprising:
first and second scanning devices positionable at a first configuration with respect to the object to be measured such that each of the scanning devices has a respective first field of view of at least a portion of the surface of the object to be measured,
wherein each of the scanning devices includes a reference object having certain reference characteristics positioned thereon,
wherein each of the scanning devices has a respective second field of view to capture at least a portion of the surface of a reference object,
wherein the scanning devices are positioned with respect one another such that the second field of view of one of the scanning devices observes at least a portion of the surface of the reference object located on the other scanning device;
the scanning devices operative to capture images of the respective portions of the surface of the object to be measured in the first field of view of each of the scanning devices;
the scanning devices operative to capture an image of the respective portion of the surface of the reference object in the second field of view of the scanning device that observes the respective portion of the surface of the reference object;
the computing device operative to transform captured images of the respective portions of the surface of the object to be measured captured at first configuration into a coordinate system of one of the reference objects;
the computing device operative to merge the images of the respective portions of the surface of the object to be measured captured at first configuration in the coordinate system of one of the reference objects;
the scanning devices repetitively repositionable one by one in an alternating manner in different configurations and:
the scanning devices operative to capture at each configuration images of the respective portions of the surface of the object to be measured in the first field of view of each of the scanning devices;
the scanning devices operative to capture at each configuration an image of the respective portion of the surface of the reference objects in the second field of view of the scanning device that observes the respective portion of the surface of the reference object;
the computing device operative to transform at each configuration captured images of the respective portions of the surface of the object to be measured and the images of the portions of the object to be measured captured and merged from prior configurations into a coordinate system of one of the reference objects;
the computing device operative to merge at each configuration the images of the respective portions of the surface of the object to be measured in the coordinate system of one of the reference objects with the images of the portions of the object to be measured captured and merged from prior configurations.

20. The system of claim 12, wherein the captured three-dimensional (3D) image of a portion of the surface of the object to be measured is obtained with a structured-light triangulation method.
